(19) United States
(12) Patent Application Publication
(10) Pub. No.: US 2025/0210994 A1
(43) Pub. Date: Jun. 26, 2025

(54) DISTRIBUTED ENERGY SYSTEMS AND METHODS OF OPERATING THE SAME

(71) Applicant: KRAKEN TECHNOLOGIES LIMITED, London (GB)

(72) Inventors: Nicholas GOOD, Clitheroe (GB); Stephen WATTAM, Marsden (GB); Csaba ZAGONI, London (GB); Meagan BURKE, Chorley (GB); Shemaiah WEEKES, Edinburgh (GB)

(73) Assignee: KRAKEN TECHNOLOGIES LIMITED, London (GB)

(21) Appl. No.: 18/848,006

(22) PCT Filed: Feb. 22, 2023
(86) PCT No.: PCT/GB2023/050400

§ 371 Date: Sep. 17, 2024

(30) Foreign Application Priority Data
Mar. 17, 2022 (GB) 2203687.5

(51) Int. Cl. H02J 3/28; H02J 3/00

(52) U.S. Cl. CPC H02J 3/28; H02J 3/004

(57) ABSTRACT

The present disclosure relates to a computer-implemented method operating an energy provision device for providing a reserve service to a power grid, comprising: determining at least one device variable, the at least one device variable comprising a power capacity of the device; and setting a power output of the device to a first power output level based on the at least one device variable using a predetermined set of constraints, the predetermined set of constraints comprising: (a) limiting the power output of the device to not exceed the power capacity of the device; and (b) limiting the power output of the device to a level at which the device is capable of maintaining for a predetermined time period.

### FIELD OF THE INVENTION

The present disclosure relates to distributed energy systems and operation of energy provision devices of the systems. In particular, the present disclosure relates to the provision of a reserve service by an energy provision device to a power system.

### BACKGROUND

The growth of power generation using renewable energy that is often variable and unpredictable, together with the retirement of large, controllable thermal power generation means has led to a reduction in inertia in the power system and a greater variation of power supply. The variation is partly offset by an increase in the deployment of battery storage and encouragement of flexible demand. However, due to a continuous increase in demand generally, for example as a result of the electrification of heat and transport, and due to an increase in the largest credible infeed loss as a result of the deployment of new interconnectors (the largest credible infeed loss may increase further when new large nuclear plant come online), there remains a need for greater procurement of frequency support services.

Demands for frequency support services has prompted the development of a new form of such services, in which service providers make their device available to be controlled by the system operator in return for an availability fee. This new form of frequency support services is open to a range of providers and is increasingly procured nearer real time and at finer resolution.

In addition to increasing frequency support services, many power systems are adapting their regulations to make those who cause imbalances in the system liable for the cost of that imbalance. The result of the regulations is that prices in power markets become more variable based on expected demands.

The result of these two trends is that there is a need for “flexible devices” to select between participating in the provision of reserve services or trading in power system markets. Herein, “flexible devices” refer to any devices capable of ramping up or down sufficiently quickly and sustain the response for a required duration. For example, flexible devices may include batteries, other forms of energy storage devices, various types of generators, various types of demand assets e.g., electrolysers, heat pumps, industrial machines, etc. Herein, “reserve services” refer services provided by a flexible device which require at least part of the total capacity of the device to be maintained in reserve so that the reserved capacity is available to provide a service when required. Frequency response is one such reserve service, and others include e.g. distribution constraint management services and other grid balancing services such as STOR (Short Term Operating Reserve) in the UK.

Currently, for a device operator, the provision of a reserve service is more preferable than trading as reserve provision has generally been more profitable. Moreover, since reserve services are procured ahead of time (e.g. months or weeks in advance), provision of reserve services offers greater certainty to the device operator in terms of operation requirement and profit. On the other hand, trading in power system markets can fluctuate and the uncertainty makes it less preferable to device operators. As such, device owners generally choose to participate in reserve provision whenever possible and only consider trading when participation in reserve services is not available.

However, such blanket preferential participation in reserve services means that devices are often not performing to full capacity and the power system is not utilised at optimal efficiency. This could lead to the power system operator procuring more capacity for reserve services to account for the reduced efficiency.

The procurement of reserve services is moving closer to real time, and services are being procured at finer resolution. Moreover, the power system markets are moving towards greater flexibility with the energy and frequency support markets being restructured to more accurately reflect operational cost in the value of participation. Thus, the value of trading and reserve provision is converging-preferential selection of reserve services over trading is no longer always the best option and does not always produce the best outcomes for the power system.

It is therefore desirable to provide improved methods and systems for optimising a device's participation in the provision of reserve services and trading in power system markets.

### BRIEF DESCRIPTION OF THE DRAWINGS

Embodiments will now be described, with reference to the accompanying drawings, in which:

FIG. 1 shows a flow diagram of an exemplary method of operating an energy provision device for provision of a reserve service, according to an embodiment;

FIG. 2 shows an exemplary set of optimisation constraints that can be implemented to the method of FIG. 1; and

FIG. 3 shows an exemplary system architecture of a distributed energy system according to an embodiment.

### DETAILED DESCRIPTION

Optimisation between participation in reserve service provision and trading in power system markets for an energy storage or generation device can be challenging.

Reserve services are often required to have the same volume across an “availability block” (the smallest unit of time for which a reserve service is procured). Determining the ability of a device to provide a required level of reserve across an availability block is not straightforward, since the device has a set of physical constraints as well as contractual and regulatory constraints which the device and device operator are required to meet. Herein, physical constraints refer to factors that determine the amount of energy the device is able to import or export in every time-step of an availability block. Herein, contractual and regulatory constraints refer to obligations imposed on the device and device operator determined by contractual terms and industry regulations. In general, the device operator commits to contractual reserve for an availability block that equals to the minimum physical reserve of the device for that availability block, such that contractual constraints are always met. However, the physical reserve of the device at a given time-step within the availability block can be higher than its contractual reserve at that time-step. If the device is operated to meet the combined constraints of physical and contractual reserves, then it is only operated at suboptimal capacity. The present technology thus provides methods and systems able to separately consider physical and contractual constraints when operating a device with a view to optimising its performance.

Across a distributed energy system, if devices within the system are allowed to be operated at different levels providing varying amount of reserve at different time-steps within an availability block, it becomes challenging to ensure a set level of reserve is provided by the system within that availability block. The present technology thus further provides a framework for structuring a plurality of devices within a distributed energy system that enables all devices to be operated at varying level while ensuring that reserve provision within the system remains constant.

In view of the foregoing, the present technology provides a computer-implemented method of operating an energy provision device for providing a reserve service to a power grid, comprising: determining at least one device parameter, the at least one device parameter comprising a power capacity of the device; and determining one or more reserve variables based on the at least one device parameter using a predetermined set of constraints, wherein the one or more reserve variables comprises a power output of the device, and the predetermined set of constraints comprising: (a) limiting the power output of the device to not exceed the power capacity of the device; and (b) limiting the power output of the device to a level at which the device is capable of maintaining for a predetermined time period.

According to embodiments of the present technology, at least one reserve variable is determined which is used to constrain an amount of device import/export reserve. Herein, the at least one reserve variable may be defined based on one or more physical properties of the device and/or one or more user-defined requirements. For example, a physical property may include e.g. a power capacity or a state of charge of the device, and a user-defined requirement may include e.g. industry regulations or contractual obligations. By constraining the amount of device import/export reserve based on at least one reserve variable, techniques described herein enable a separation of device physical properties from regulation or contractual obligations. It is thus possible to optimise a device import/export reserve according to the physical state of a device to allow the device to potentially be operated at full capacity.

In some embodiments, the at least one device parameter may comprise a current state of charge of the device, and the predetermined set of constraints may comprise (c) limiting the power output of the device to a level at which a state of charge of the device is above a lower limit for the predetermined time period.

In some embodiments, the at least one device parameter may comprise a power output limit set by a user, and the predetermined set of constraints may comprise (d) limiting the power output of the device to not exceed the power output limit set by the user.

In some embodiments, the predetermined set of constraints comprises (e) when the device provides a reserve service for a plurality of predetermined time periods, requiring that the power output of the device to be substantially the same across all of the plurality of predetermined time periods.

In some embodiments, the method may further comprise defining the one or more reserve variables based on one or more physical properties of the device and/or one or more user-defined requirements.

In some embodiments, the energy provision device may be an energy storage device, and the method may comprise operating the device to store energy from the power grid.

In some embodiments, the method may further comprise operating the device to store energy from the power grid when energy generation exceeds energy demands.

In some embodiments, the device may store energy from the power grid based on the at least one device parameter using the predetermined set of constraints, the predetermined set of constraints comprises: (a′) limiting a power input of the device to not exceed the power capacity of the device; and (c′) limiting the power input of the device to a level at which a state of charge of the device is below an upper limit.

In some embodiments, the predetermined set of constraints may comprise forbidding simultaneous provision of a reserve service and energy trading, for example by allocating proportions of device capacity in a given time-step to each of reserve provision and energy trading. This may be imposed to ensure a system operator meets requirements when procuring frequency support services.

Another aspect of the present technology provides a computer-readable storage medium comprising machine-readable code, which, when executed by a processor, causes the processor to perform the method as described above.

A further aspect of the present technology provides a control device for operating an energy provision device to provide a reserve service to a power grid configured to perform the method as described above.

A yet further aspect of the present technology provides a distributed energy system for providing power to a power grid, comprising: a plurality of energy provision devices each having respective at least one device parameter and each configured to output power based on one or more respective device reserve variables; and a control module configured to control operation of the plurality of devices by determining the one or more respective reserve variables for each of the plurality of devices based on the respective at least one device parameter using a predetermined set of constraints, wherein the plurality of devices is arranged into one or more portfolios, each portfolio having assigned thereto a portfolio power output, and, for a given portfolio, the control module is configured to determine the one or more respective reserve variables of one or more devices in the given portfolio such that devices in the given portfolio collectively output power substantially at the portfolio power output for the given portfolio for a predetermined time period.

According to embodiments of the present technology, structuring a plurality of devices into one or more portfolios allow reserve provision by devices in the same portfolio to vary across time-steps within an availability block (predetermined time period), as long as the overall reserve provision by the portfolio is maintained at the same level at all time-steps within the availability block. Thus, the portfolio structure of the present technology provides flexibility to individual devices. The improved flexibility in reserve provision and capacity allocation enables the co-optimisation of energy trading and reserve provision, in that device operators are able to optimally allocate capacity between the two options. Present techniques therefore enable the power system to be operated more efficiently.

In some embodiments, the given portfolio may comprise one or more sites, each site comprising one or more devices.

In some embodiments, the energy provision device may be an energy generation device including an electrical generator, a thermal generator, an electrolyser or a heat pump, or the energy provision device is an energy storage device configured to store energy from the power grid and output the stored energy on demand.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### Device-Level Reserve Optimisation

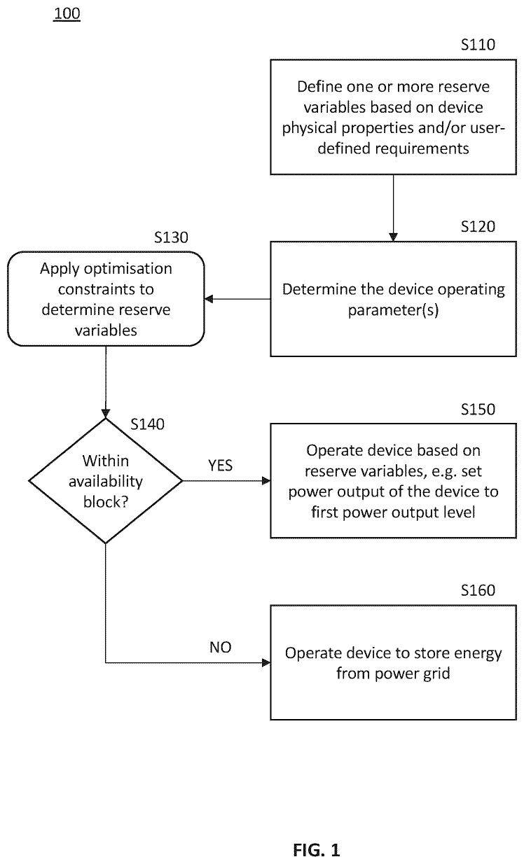

A method 100 of operating an energy provision device (an energy storage device or an energy generation device) for providing a reserve service to a power system according to an embodiment is illustrated in FIG. 1.

The method begins at S110, where one or more import/export reserve variables for a device are defined. The number of device variables defined may differ amongst different devices as desired and may be dependent on the physical properties of the device and/or contractual terms for its operation as well as industry regulations. The reserve variables of a device determine how the device will be operated.

At S120, at least one device operating parameter is determined. The determined at least one device operating parameter is used as input for optimisation of the device operation by applying a predetermined set of constraints at S130. The optimisation returns a set of values for the defined one or more reserve variables for the device based on the at least one device operating parameter. During an availability block (predetermined time period), S140, the device is operated at S150 based on the set of values for the one or more reserve variables such as by setting the power output of the device to a first power output level e.g. based on a constraint on the power capacity of the device.

The device may be operated to use, store (or buy) or provide (or sell) energy if the device has the capacity to do so, provided that a sufficient portion of the device capacity has been set aside for the required reserve provision. For example, when the device has met its required reserve provision, for example, when the device is operating outside of an availability block, the device may be operated at S160 to store energy from the power system. According to an embodiment, provision of import reserve by the device may be optimised based again on the at least one device operating parameter and using the predetermined set of constraints. For example, the device may be required to store energy generated in excess when energy generation exceeds demands on energy from the power system in preparation for providing reserve at a time when demands exceed energy generation.

The optimisation performed at S130 may implement one or more constraints on the operation of the device based on one or more device operating parameters. For example, by applying a limit to ensure that the amount of device import/export reserve is prohibited to be greater than the import/export capacity (e.g. in units of power) of the device. If required, the optimisation may apply a limit to ensure that the amount of device import/export reserve is prohibited to be greater than (or less than) a limit set by the device operator. If required, the optimisation may ensure that the amount of reserve provided by the device remains the same across multiple availability blocks (as defined by the device operator). If the device is “energy-limited” (e.g., the device is an energy storage device with a fixed capacity, such as a battery), the optimisation may ensure that the device is capable of providing a desired amount of device import/export reserve for the duration prescribed by the device operator, without the state-of-charge of the device reaching its upper (for import) or lower (for export) limit. If required, the optimisation may forbid simultaneous provision of reserve and trading, so as to comply with requirements imposed on the system operator when procuring frequency support services. This may for example be realised by allocating proportions of device capacity in a given time-step to each of reserve provision and trading. If required, the optimisation may ensure that import and export reserve power values for the device are equal.

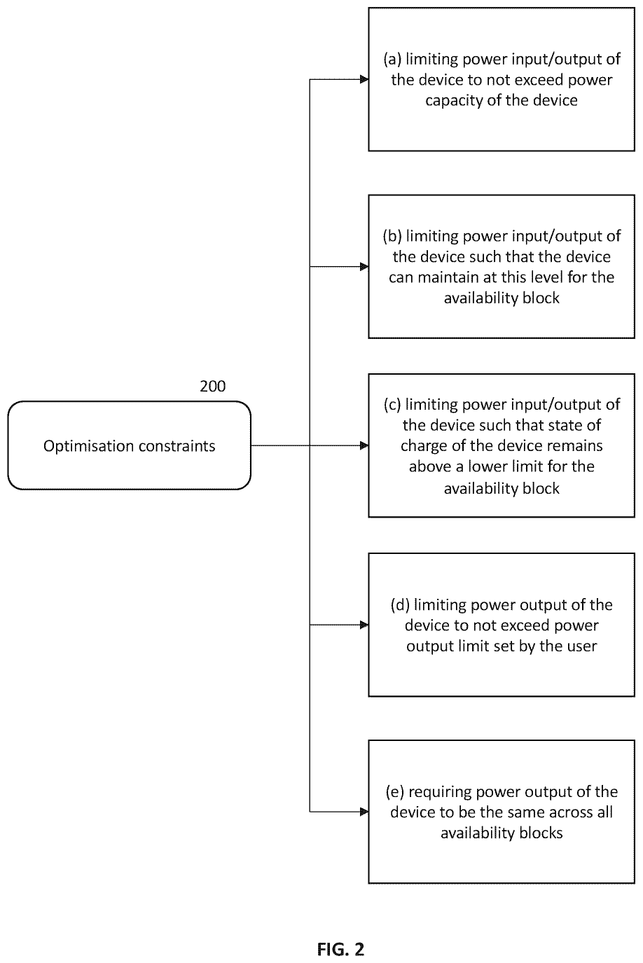

FIG. 2 schematically shows a set of optimisation constraints 200 that can be implemented in the method 100.

In the embodiment, the set of optimisation constraints 200 includes:
(a) limiting power input/output of the device to not exceed power capacity of the device;
(b) limiting power input/output of the device such that the device can maintain at this level for the availability block;
(c) limiting power input/output of the device such that state of charge of the device remains above a lower limit for the availability block;
(d) limiting power output of the device to not exceed power output limit set by the user; and
(e) requiring power output of the device to be the same for all time steps within each availability block.

### Portfolio-Level Reserve Optimisation

According to an embodiment, within the optimisation framework, devices sit within sites, and sites are organised into portfolios.

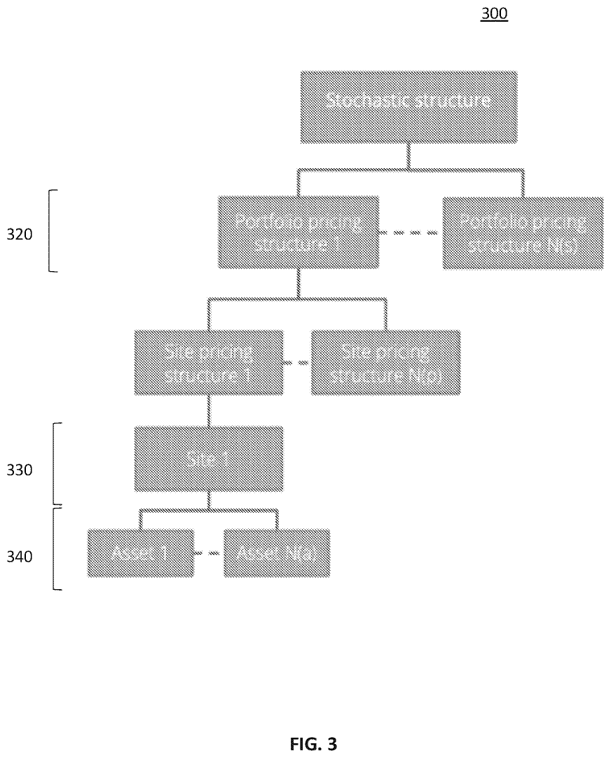

FIG. 3 schematically shows an exemplary system architecture 300 within the optimisation framework according to an embodiment. Each portfolio 320 is divided into sites 330, in which energy trading and/or reserve provision are handled. Each site 330 has a site pricing structure in which site-level charges are handled.

Assets, or devices, 340 are grouped into sites. Devices 340, e.g. electrical generators, storage units, flexible demand units, etc., are defined by specifying various mandatory and optional parameters (e.g., max electricity export, max electricity import, efficiency).

Through structuring a system comprising a plurality of devices according to the embodiments, it is possible to enable reserve provision by the plurality of devices to vary across time-steps within an availability bock while ensuring that the overall reserve provision of the system at all time-steps within the availability block is maintained, by requiring reserve provision to meet a predetermined level across the availability block at the portfolio level, rather than at the device level. For example, by requiring the reserve variables for the portfolio of devices to maintain the same value for every time step within the availability block, while allowing the reserve variables for individual devices in the portfolio to be different. It is therefore possible for individual device to be operated above minimum capacity at varying level without resulting in uncertainty in reserve provision.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

1. A computer-implemented method of operating an energy provision device for providing a reserve service to a power grid, comprising:
determining at least one device parameter, the at least one device parameter comprising a power capacity of the device; and
determining one or more reserve variables based on the at least one device parameter using a predetermined set of constraints, wherein the one or more reserve variables comprises a power output of the device, and the predetermined set of constraints comprising:
(a) limiting the power output of the device to not exceed the power capacity of the device; and
(b) limiting the power output of the device to a level at which the device is capable of maintaining for a predetermined time period.

2. The method of claim 1, wherein the at least one device parameter comprises a current state of charge of the device, and wherein the predetermined set of constraints comprises (c) limiting the power output of the device to a level at which a state of charge of the device is above a lower limit for the predetermined time period.

3. The method of claim 1, wherein the at least one device parameter comprises a power output limit set by a user, and wherein the predetermined set of constraints comprises (d) limiting the power output of the device to not exceed the power output limit set by the user.

4. The method of claim 1, wherein the predetermined set of constraints comprises (e) when the device provides a reserve service for a plurality of predetermined time periods, requiring that the power output of the device to be substantially the same across all of the plurality of predetermined time periods.

5. The method of claim 1, further comprising defining the one or more reserve variables based on one or more physical properties of the device and/or one or more user-defined requirements.

6. The method of claim 1, wherein the energy provision device is an energy storage device, and the method comprises operating the device to store energy from the power grid.

7. The method of claim 6, further comprising operating the device to store energy from the power grid when energy generation exceeds energy demands.

8. The method of claim 6, wherein the device stores energy from the power grid based on the at least one device parameter using the predetermined set of constraints, the predetermined set of constraints comprises:
(a′) limiting a power input of the device to not exceed the power capacity of the device; and
(c′) limiting the power input of the device to a level at which a state of charge of the device is below an upper limit.

9. The method of claim 1, wherein the predetermined set of constraints comprises forbidding simultaneous provision of a reserve service and energy trading.

10. A computer-readable medium comprising machine-readable code, which, when executed by a processor, causes the processor to perform the method of claim 1.

11. A control device for operating an energy provision device to provide a reserve service to a power grid configured to perform the method of claim 1.

12. A distributed energy system for providing power to a power grid, comprising:
a plurality of energy provision devices each having respective at least one device parameter and each configured to output power based on one or more respective device reserve variables; and
a control module configured to control operation of the plurality of devices by determining the one or more respective reserve variables for each of the plurality of devices based on the respective at least one device parameter using a predetermined set of constraints,
wherein the plurality of devices is arranged into one or more portfolios, each portfolio having assigned thereto a portfolio power output, and, for a given portfolio, the control module is configured to determine the one or more respective reserve variables of one or more devices in the given portfolio such that devices in the given portfolio collectively output power substantially at the portfolio power output for the given portfolio for a predetermined time period.

13. The system of claim 12, wherein the given portfolio comprises one or more sites, each site comprising one or more devices.

14. The system of claim 12, wherein, for a given device, the at least one device parameter comprises a power capacity of the device, and the predetermined set of constraints comprises (a) limiting the power output of the device to not exceed the power capacity of the device.

15. The system of claim 12, wherein, for a given device, the at least one device parameter comprises a power capacity of the device, and the predetermined set of constraints comprises (b) limiting the power output of the device to a level at which the device is capable of maintaining for the predetermined time period.

16. The system of claim 12, wherein for a given device, the at least one device parameter comprises a current state of charge of the device, and the predetermined set of constraints comprises (c) limiting the power output of the device to a level at which a state of charge of the device is above a lower limit for the predetermined time period.

17. The system of claim 12, wherein for a given device, the at least one device parameter comprises a power output limit set by a user, and the predetermined set of constraints comprises (d) limiting the power output of the device to not exceed the power output limit set by the user.

18. The system of claim 12, wherein for a given device, the predetermined set of constraints comprises (e) when the device provides a reserve service for a plurality of predetermined time periods, requiring that the power output of the device to be substantially the same across all of the plurality of predetermined time periods.

19. The system of claim 12, wherein the energy provision device is an energy generation device including an electrical generator, a thermal generator, an electrolyser or a heat pump, or the energy provision device is an energy storage device configure to store energy from the power grid and output the stored energy on demand.
